(19) United States
(12) Patent Application Publication
(10) Pub. No.: US 2017/0068757 A1
(43) Pub. Date: Mar. 9, 2017

(54) SIMULATION DEVICE FOR SEMICONDUCTOR DEVICE, AND SHORT-CIRCUIT DETERMINATION METHOD FOR SEMICONDUCTOR DEVICE

(71) Applicant: Kabushiki Kaisha Toshiba, Minato-ku (JP)

(72) Inventor: Ryota NIHEI, Yokkaichi (JP)

(73) Assignee: Kabushiki Kaisha Toshiba, Minato-ku (JP)

(21) Appl. No.: 15/063,707

(22) Filed: Mar. 8, 2016

Related U.S. Application Data
(60) Provisional application No. 62/215,299, filed on Sep. 8, 2015.

(51) Int. Cl. G06F 17/50

(52) U.S. Cl. CPC G06F 17/5009

(57) ABSTRACT

the design data and the simulation data includes a comparator, an identification code assigning unit, and a short-circuit determining unit. The comparator is configured to compare design data of a semiconductor device with simulation data of the semiconductor device to extract areas different therebetween. With reference to the extracted areas extracted by the comparator, the identification code assigning unit is configured to assign different identification codes to the extracted areas corresponding to different conductors The short-circuit determining unit determines whether the extracted areas to which the different identification codes have been assigned are within a predetermined distance or not to determine a short circuit position in the semiconductor device.

### CROSS REFERENCE TO RELATED APPLICATIONS

This application is based on and claims the benefit of priority from prior U.S. prior provisional Patent Application No. 62/215,299, filed on Sep. 8, 2015, the entire contents of which are incorporated herein by reference.

### FIELD

Embodiments described herein generally relate to a simulation device for semiconductor device and a short-circuit determination method for semiconductor device.

### BACKGROUND

In product development of semiconductor devices, a simulation process may find in what case and where a short circuit occurs, whereby reduced development costs and shortened period necessary for research and development may be obtained. However, in the case where the simulations of the semiconductor devices handle a large area to be simulated, accurately determining the location of short circuit in the complicated semiconductor structure requires considerable time and labor. It is extremely difficult to thoroughly examine the short circuit position accurately in a development period set for the product development for the semiconductor devices.

### BRIEF DESCRIPTION OF THE DRAWINGS

FIG. 1 is an exemplary block diagram illustrating an overall structure of a simulation device of a first embodiment;

FIG. 2 is a plan view illustrating a part of the structure of the semiconductor device target for simulation with the simulation device of the first embodiment;

FIG. 3A to FIG. 3C and FIG. 4 are conceptual diagrams illustrating operations of an identification code assigning unit 211;

FIG. 5 is a flowchart showing a procedure for a short-circuit determination method that can be executed by the simulation device of the first embodiment;

FIG. 6 to FIG. 8 are conceptual diagrams illustrating a procedure to obtain design data Dd, simulation data Ds, and an extracted area De;

FIG. 9 is a conceptual diagram illustrating a procedure for a short-circuit determination method that can be executed by a simulation device of a second embodiment;

FIG. 10 is a flowchart showing a procedure for the short-circuit determination method that can be executed by the simulation device of the second embodiment; and

FIG. 11 and FIG. 12 illustrate modifications.

### DETAILED DESCRIPTION

A simulation device for a semiconductor device according to embodiments described later includes a comparator, an identification code assigning unit, and a short-circuit determining unit. The comparator is configured to compare design data of a semiconductor device with simulation data of the semiconductor device to extract areas different between the design data and the simulation data. The identification code assigning unit is configured to assign, with respect to extracted areas extracted by the comparator, different identification codes to the extracted areas corresponding to different conductors. The short-circuit determining unit determines whether the extracted areas to which the different identification codes have been assigned are within a predetermined distance or not to determine a short circuit position in the semiconductor device.

### First Embodiment

The following describes details of a simulation device for semiconductor device according to the first embodiment with reference to the drawings.

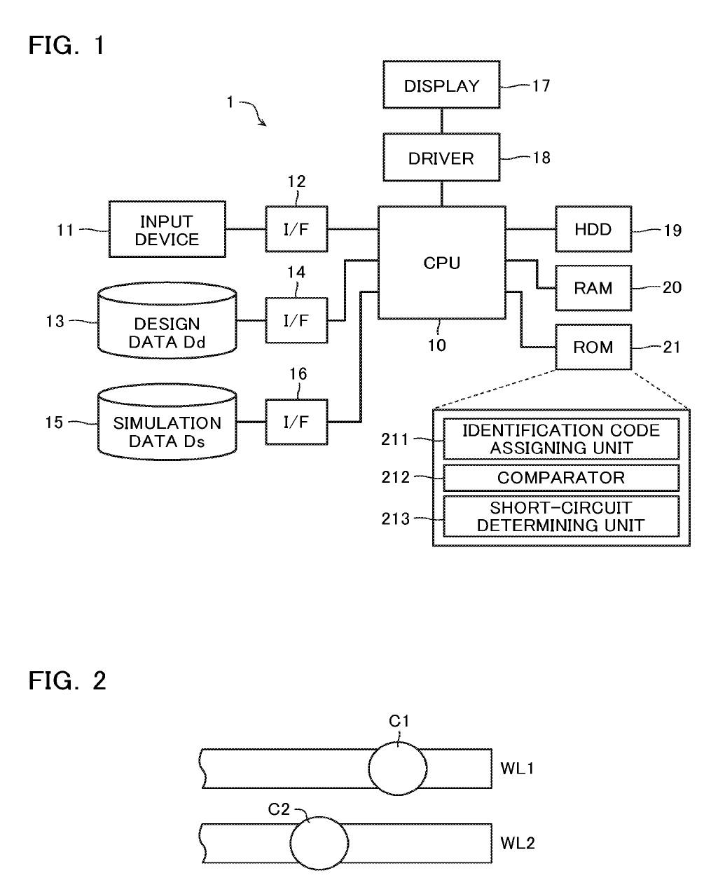

FIG. 1 is an exemplary block diagram illustrating an overall structure of a simulation device of a first embodiment. This simulation device includes a CPU 10, an input device 11, an interface 12, a design data storage unit 13, an interface 14, a simulation data storage unit 15, an interface 16, a display 17, a driver 18, a hard disk drive 19, a RAM 20, and a ROM 21.

The CPU 10 is an arithmetic processing unit, which executes various operations provided by software for this simulation device. The input device 11 is an input device for the user to input various instructions and data. The input device 11 can be constituted of, for example, a keyboard, a computer mouse, a touchscreen, or a combination of these devices. The various data input from the input device 11 is supplied to the CPU 10 via the interface 12.

The design data storage unit 13 is a storage device to store design data Dd of the semiconductor device to be designed. The design data Dd includes not only shape data of final structure of the semiconductor device to be designed but also includes data of a shape of an intermediate product, which is obtained in the middle of the manufacturing process. This design data also includes the shape data of various products that are removed in the middle of the manufacturing process and therefore do not remain in the final structure, such as various masks, sacrifice films, and contact holes. The data read from the design data storage unit 13 is supplied to the CPU 10 via the interface 14.

The simulation data storage unit 15 is a storage device that stores simulation data Ds. The data read from the simulation data storage unit 15 is supplied to the CPU 10 via the interface 16.

Here, the simulation data Ds herein means data obtained by predicting the shapes of respective components that are to be obtained when a semiconductor device to be designed is manufactured by a certain manufacturing process, considering various types of manufacturing errors. Similar to the design data Dd, this simulation data Ds also includes the shape data of various structures, which are obtained in the middle of the manufacturing process. Ideally, the shapes of the respective components of the semiconductor device in the simulation data Ds are preferably identical to the design data Dd. However, due to a manufacturing error or a similar error, the simulation data Ds often differs from the design data Dd.

The display 17 displays the design data Dd, the simulation data Ds, and various input data and output data. The driver 18 is a display control unit that controls the display 17 to cause the display 17 to display the input data and arithmetic processing results.

The hard disk drive 19 stores short-circuit determination results obtained by the CPU 10, other data, or similar data in a non-volatile manner. Besides, the hard disk drive 19 has a function to store various data. The RAM 20 is a storage unit to temporarily store the obtained arithmetic operation results and determination results. The ROM 21 stores simulation software as the core part of the simulation device. This simulation software functions as an identification code assigning unit 211, a comparator 212, and a short-circuit determining unit 213. Instead of being stored on the ROM 21, this software may be stored on the hard disk drive 19 or may be stored on a portable storage medium (DVD-ROM, CD-ROM, or a similar medium) (not illustrated).

The identification code assigning unit 211 has a function to assign identification codes for data of respective conductors included in the design data Dd, which are read from the design data storage unit 13. The identification code assigning unit 211 assigns the different identification codes to the different conductors electrically independent of one another. The identification codes are typically numerals; however, the identification codes may also be other characters such as the English alphabets and the Greek alphabets. Alternatively, the characters may be a combination of a plurality of types of the codes, and any types are applicable. The identification code assigning unit 211 has a function of assigning, also to extracted areas extracted by the comparator 212 which will be described later, identification codes identical to the identification codes assigned to the corresponding design data Dd.

The comparator 212 has a function of comparing the design data Dd which is read from the design data storage unit 13, with the simulation data Ds which is read from the simulation data storage unit 15, to extract (specify) an extracted area De that indicates the difference between the design data Dd and the simulation data Ds. Due to various manufacturing errors in the manufacturing process, the simulation data Ds is not identical to the design data Dd but has a minute difference. In view of this, the comparator 212 extracts this difference as the extracted area De. The identification code assigning unit 211 assigns an identification code identical to the identification code assigned to the corresponding design data Dd to the extracted area De, which is specified by the comparator 212.

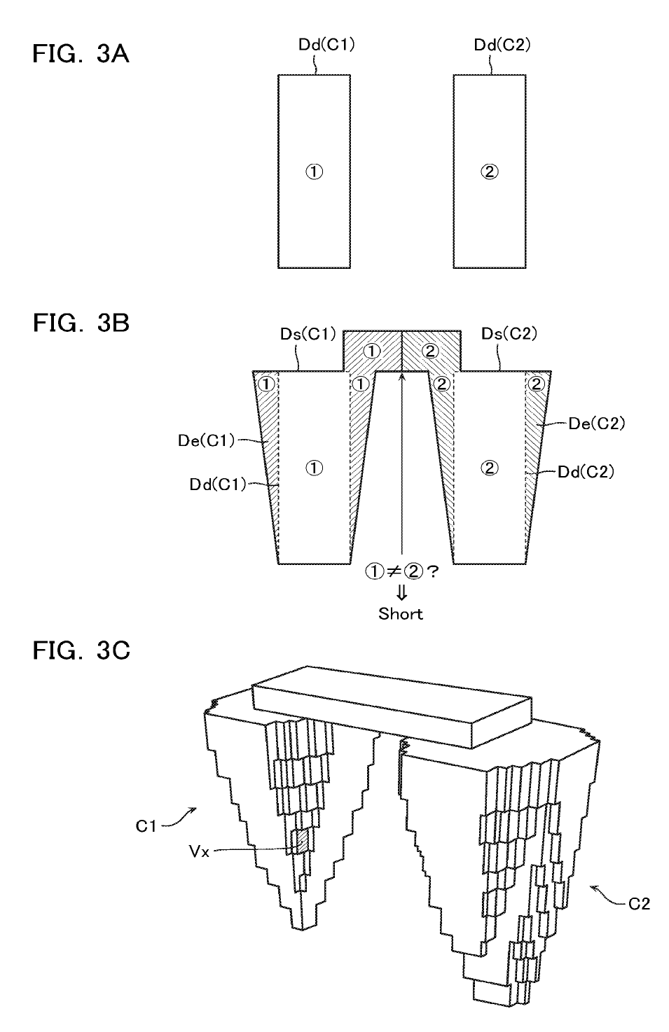

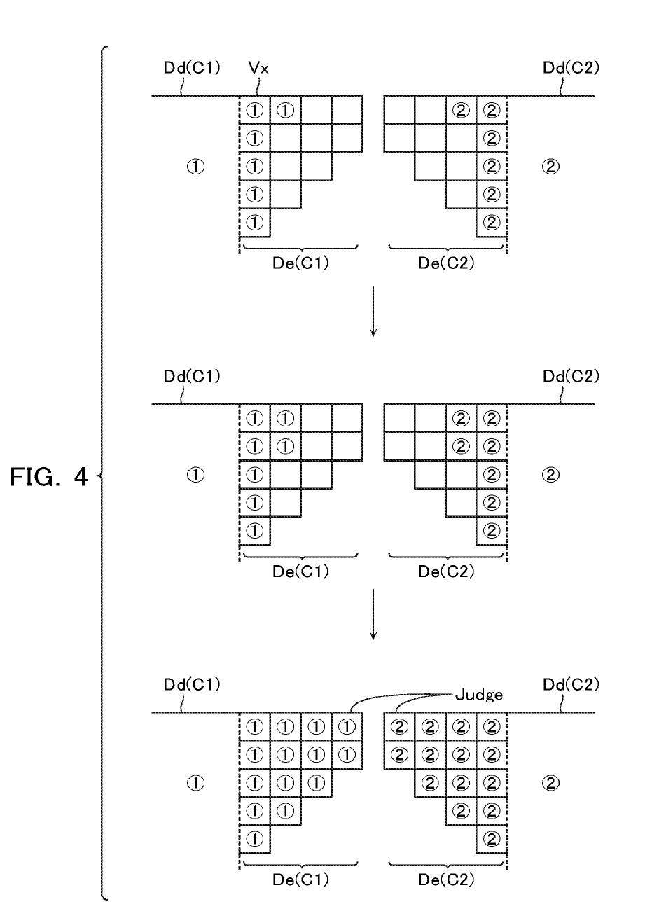

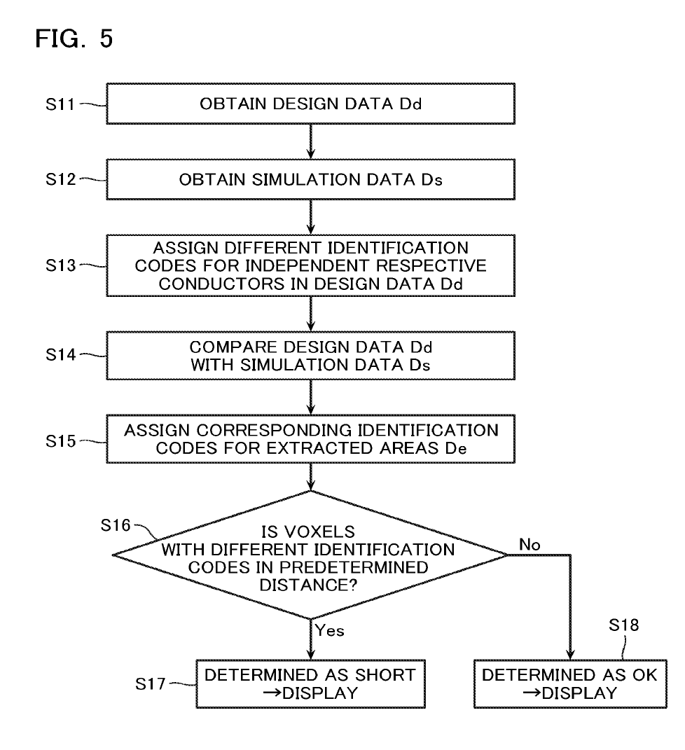

Here, with reference to FIG. 2, FIG. 3A, FIG. 3B, FIG. 3C, FIG. 4, and FIG. 5, the following describes the short-circuit determination method and a procedure for assigning the identification codes by the identification code assigning unit 211 according to the embodiments. FIG. 2 is a plan view illustrating a part of the structure of the semiconductor device. FIG. 3A to FIG. 3C and FIG. 4 are conceptual diagrams illustrating operations of the identification code assigning unit 211. FIG. 5 is a flowchart showing the procedure for the short-circuit determination method. The following describes the case where Arabic numerals, 1, 2, 3, and so on, are assigned as the identification codes as an example. However, needless to say, this example is not described to limit the identification codes to the Arabic numerals. As illustrated in FIG. 2, the following description assumes the case where the design-target semiconductor device includes a plurality of wirings WL1 and WL2 and contacts C1 and C2. The wirings WL1 and WL2 are electrically independent of one another. The contacts C1 and C2 are connected to the wirings WL1 and WL2, respectively. This is merely a simplified example, and needless to say, this example does not limit the embodiment.

In this short-circuit determination method, first, the design data Dd is read from the design data storage unit 13 and the simulation data Ds is read from the simulation data storage unit 15, thus obtaining the data (Steps S11 and S12 in FIG. 5). In this case, the design data Dd (C1) and Dd (C2) regarding the contacts C1 and C2, which are conductors electrically independent of one another, are, for example, given as shape data with rectangular cross section as illustrated in FIG. 3A.

Subsequently, the identification code assigning unit 211 gives different identification codes “1” and “2” to these design data Dd (C1) and Dd (C2), respectively (Step S13 in FIG. 5).

Next, the design data Dd and the simulation data Ds, which are read at Steps S11 and S12, are compared. The extracted areas De as the differences therebetween are extracted (Step S14 in FIG. 5). As one example, as illustrated in FIG. 3B, the simulation data Ds (C1) and Ds (C2) of the contacts C1 and C2 do not have the rectangular cross-section like the design data Dd, which is illustrated in FIG. 3A. The simulation data Ds (C1) and Ds (C2), for example, have a forward tapered shape whose cross-sectional diameter in the planar direction gradually decreases. This difference in shape between the design data Dd and the simulation data Ds is caused by properties of an etching method, an etching apparatus, or a similar condition employed to form a contact hole. The forward tapered shape is merely one example, and the simulation data with another shape may be obtained. However, generally, the design data Dd differs from the simulation data Ds. This possibly causes a short-circuit state. If the difference between both data is large, a conductive film is formed at a part not assumed in the design data Dd. This increases a possibility of causing a short-circuit state between different conductors, which should be electrically independent of one another.

Therefore, the embodiment performs the following procedure on the extracted areas De, which are obtained by the comparison result at Step S14.

That is, the identification code assigning unit 211 of the embodiment assigns the identification codes corresponding to the identification codes assigned to the corresponding design data Dd (for example, the identical identification codes) to the extracted areas De, which are extracted by the comparator 212 (Step S15 in FIG. 5).

For example, as illustrated in FIG. 3B, to the extracted area De (C1) regarding the contact C1, the identification code identical to the identification code assigned to the design data Dd (C1), “1”, is assigned. Similarly, for the extracted area De (C2), the identification code identical to the identification code assigned to the design data Dd (C2), “2”, is assigned.

The actual contacts C1 and C2 have a three-dimensional structure. Accordingly, the design data Dd and the simulation data Ds are also three-dimensional data as illustrated in FIG. 3C. The design data Dd and the simulation data Ds are expressed as a collection of a voxel Vx, which is a minimum solid unit. In view of this, the identification code assigning unit 211 assigns the identification codes for each voxel Vx. Specifically, as illustrated in FIG. 4, whenever one voxel Vx is specified, the identification code identical to the identification code assigned to the design data Dd (C1) corresponding to the voxel Vx, “1”, is assigned to the voxel Vx in the extracted area De (C1). After that, the similar procedure is repeated on the all voxels Vx in the extracted area De (C1). The similar procedure is performed also on the voxels Vx in the extracted area De (C2).

When the assignment of the identification codes for the all voxels Vx is thus terminated, subsequently, the short-circuit determining unit 213 determines whether the voxels to which different identification codes have been assigned are present in a predetermined distance or not (S16). When the voxels Vx to which different identification codes have been assigned are present within the predetermined distance from one another, the short-circuit determining unit 213 can determine that the contacts C1 and C2 possibly cause the short circuit (S17). The display 17 or a similar unit displays the determination result. Meanwhile, when the voxels Vx to which different identification codes have been assigned are not present within the predetermined distance from one another, the short circuit does not occur. Therefore, the short-circuit determining unit 213 determines the determination-target semiconductor device as a fine product. The display 17 or a similar unit displays the determination result (S18). Here, the short-circuit determining unit 213 can determine whether the two voxels are present within the predetermined distance or not by differences in the X coordinate, Y coordinate, and Z coordinate between the two voxels.

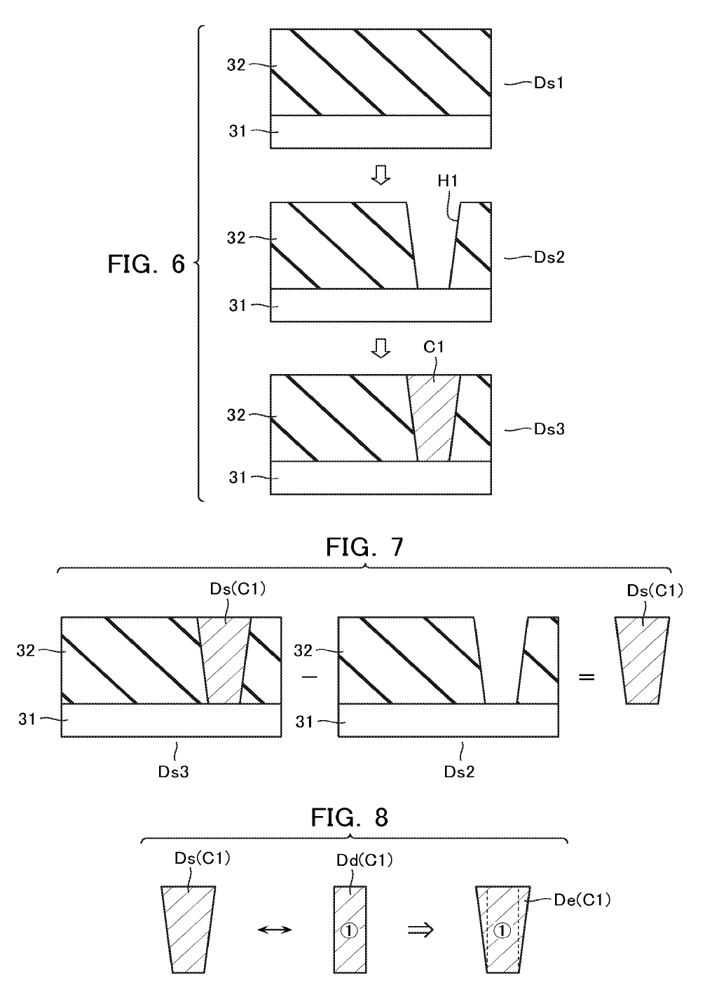

The simulation data Ds is, for example, as illustrated in FIG. 6, stored as shape data for each manufacturing process step. In view of this, the respective components, for example, the shape of the contact C1 can be obtained by subtracting simulation data Ds2, which is at the step one prior to this step before forming the contact C1, from simulation data Ds3, which is at the step of forming the contact C1 (see FIG. 7). Although the illustration is omitted, the same applies to the design data Dd. The comparison between the simulation data Ds and the design data Dd thus obtained allows obtaining the data of the extracted area De (see FIG. 8).

Thus, according to the simulation device and the short-circuit determination method of this first embodiment, the design data Dd and the simulation data Ds are compared to extract the extracted areas De. The identification codes are assigned in the extracted areas De. Then, whether the extracted areas De to which different identification codes have been assigned are within the predetermined distance or not is determined, thus determining the short circuit position. Accordingly, the first embodiment allows easily determining the short circuit position in the semiconductor device in a short time.

### Second Embodiment

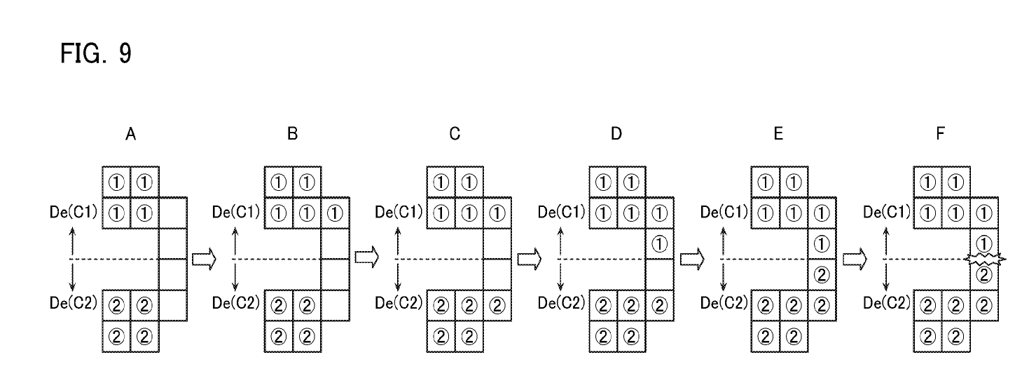

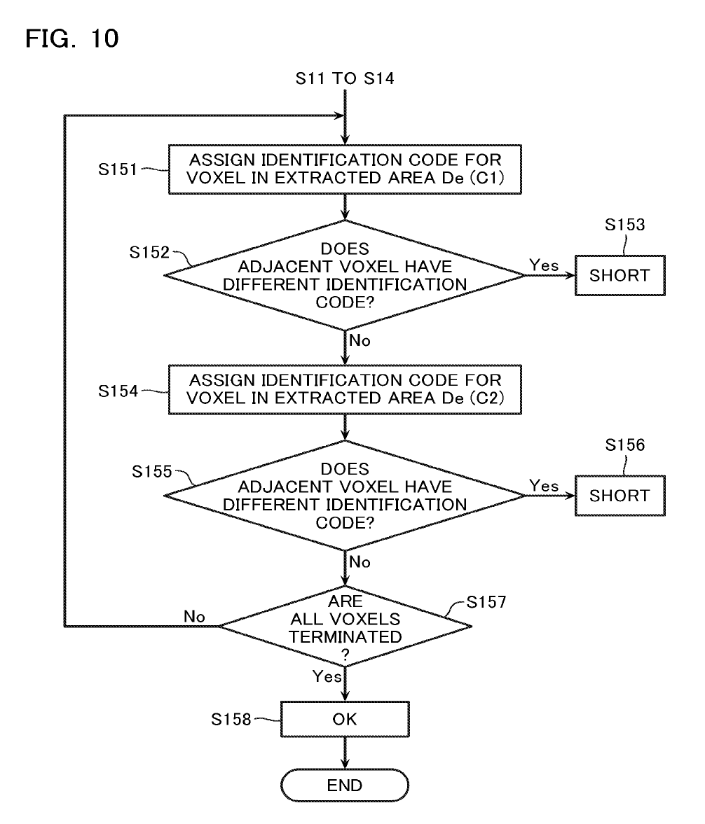

Next, the following describes the simulation device and the short-circuit determination method of the second embodiment with reference to FIG. 9 and FIG. 10.

The overall structure of the simulation device of this second embodiment may be similar to the first embodiment (FIG. 1). Although the basic operations are also similar to the first embodiment, the second embodiment differs from the first embodiment in the procedures for the assignment of identification codes and the short-circuit determination.

FIG. 9 is a conceptual diagram illustrating the procedure for the short-circuit determination method of the second embodiment. FIG. 10 is a flowchart for the procedure.

FIG. 9 illustrates the procedure for assigning the identification codes in the case where the identification codes are two types, “1” and “2.” As illustrated in A to F of FIG. 9, the identification code “1” is assigned to one voxel in the extracted area De (C1). Then, the identification code “2” is assigned to one voxel in the extracted area De (C2). After that, this procedure is repeated.

Whenever an identification code is assigned to a voxel, this second embodiment determines whether another voxel having an identification code different from that identification code is adjacent to this voxel (within the predetermined distance) or not. When the other voxel with a different identification code is determined as being adjacent thereto, it is determined that the short circuit occurs in this position, and the display 17 displays the determination result. When the other voxel is determined as not being adjacent thereto, the procedure to assign the identification codes is repeated.

FIG. 10 is a flowchart describing a specific procedure.

Similar to the first embodiment, after the execution of Steps S11 to S14 in FIG. 5, the identification code “1” is assigned to one voxel in the extracted area De (C1) (Step S151). Afterwards, whether the voxel is adjacent to the voxel to which the identification code (“2”), which is different from “1”, has been assigned or not is determined (Step S152). When determined as adjacent, the process transitions to Step S153. The display 17 displays the determination result that the position near the voxel is the short circuit position.

Meanwhile, when determined as not adjacent, the process transitions to Step S154. The identification code “2” is assigned to one voxel in the extracted area De (C2). Afterwards, whether the voxel is adjacent to the voxel to which the identification code (“1”), which is different from “2”, has been assigned or not is determined (Step S155). When determined as adjacent, the process transitions to Step S156. The display 17 displays the determination result that the position near the voxel is the short circuit position.

Meanwhile, when determined as not adjacent, the process transitions to Step S157. It is determined whether the assignment of the identification codes for all the voxels in the extracted areas De has been terminated or not (Step S158). When terminated, it is determined that the short circuit does not occur and the short-circuit determination operation is terminated. Meanwhile, if the voxel for which the assignment of the identification code has not been completed remains, the process returns to Step S151 to repeat the above-described operations.

For simplification of the description, the above-described descriptions of FIG. 9 and FIG. 10 use two types of identification codes, “1” and “2.” The procedure for assigning the identification codes in alternation to the extracted areas De (C1) and De (C2) corresponding to the contacts C1 and C2, which are two independent conductors, is described above. Needless to say, this does not mean that the embodiments is limited to this procedure. The types of the identification codes may be any number of equal to or more than three. Additionally, the number of voxels to which one identification code is assigned at one step is not limited to one.

Thus, according to the second embodiment, the advantage similar to the first embodiment can be obtained. Additionally, according to the second embodiment, whenever the identification code is assigned to the voxel, the short-circuit determination is performed. This allows shortening the time required for the short-circuit determination.

### [Modification]

The above-described embodiments describe the example where the identification codes are assigned to the design data Dd of the conductive films and the extracted areas De. However, this is merely one example of the embodiments. This does not mean that the embodiment is limited to the examples described and illustrated above. For example, like the following description, the aspect that assigns the identification codes for the design data Dd and the extracted areas De that are not for the conductive films is also included in the scope of the above-described embodiments.

### (1) Modification 1

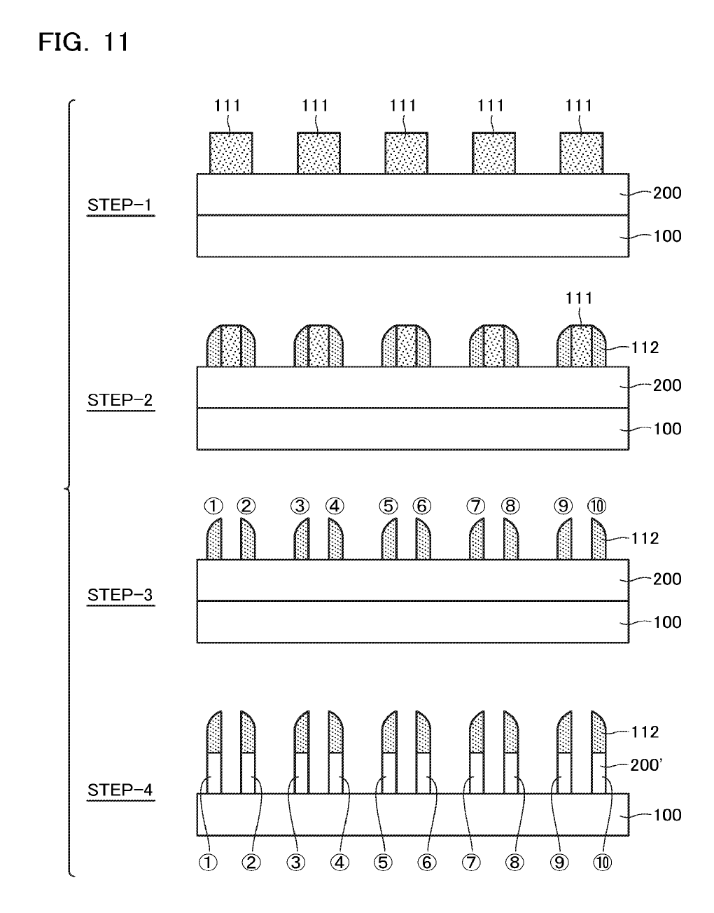

FIG. 11 is a conceptual diagram describing the assignment of the identification codes in the case where a so-called sidewall transfer process is performed.

In response to the request for further minuteness in recent years, a so-called sidewall transfer technology has been used to process various wirings to a line width equal to or less than the resolution limit of lithography. The following describes the outline of the sidewall transfer technology with reference to FIG. 11.

First, on a semiconductor substrate 100, a wiring material 200 for forming a wiring layer, which will be a word line WL, is deposited. Hard masks 111 are formed on the wiring material 200. As illustrated in STEP-1 in FIG. 11, this hard mask 111 is patterned to be a desired wiring pattern by photolithography and etching using a resist (not illustrated).

Next, as illustrated in STEP-2, by isotropic etching, a so-called slimming process is performed to thin the width of the hard mask 111. Afterwards, a thin film, which will be a sidewall film for the sidewall transfer process, is deposited on the entire surface including the sidewalls of these hard masks 111. In the thin film, the films deposited on the top surfaces of the hard masks 111 and the top surface of the wiring material 200 are removed by etching using anisotropic etching or similar etching. Thus, sidewall films 112 for sidewall process are formed only on the sidewalls of the hard masks 111.

The hard mask 111 can be constituted of, for example, a BSG film. The sidewall film 112 is made of a material whose selectivity relative to the hard mask 111 is high. For example, in the case where the hard mask 111 is formed of the BSG film, for example, a silicon nitride film can be formed as the material.

Next, as illustrated in STEP-3, the hard masks 111 are removed by etching using wet etching using an alkaline solution to leave only the sidewall films 112 whose selectivity relative to the hard masks 111 is high. Afterwards, as illustrated in STEP-4, by the anisotropic etching using these sidewall films 112 as the masks, the wiring material 200 is etched to form wiring layers 200′. The sidewall films 112 are formed so as to have a closed-loop shape and cover the outer periphery of the patterned hard mask 111. Therefore, the wiring layer 200′ is also formed into the closed-loop shape along this sidewall film 112. The wiring layers 200′ formed into the closed-loop shape are cut at any of the positions and are used as the various wirings. In the case of a NAND flash memory, the closed loop is cut off at any two positions in the closed-loop shape. Thus, two open-loop shaped wirings are formed from the one closed-loop shape wiring. Thus, from the hard mask formed at a wiring pitch of 4F by lithography at a resolution limit of 2F, a line-and-space pattern at a wiring width of F and a wiring pitch of 2F (an interval F) can be formed.

After removing the hard masks 111, sidewall films are further formed on the sidewalls of the sidewall films 112. The sidewall films 112 are removed and these sidewall films are left. Thus, it is also possible to achieve further minuteness.

When executing such sidewall transfer process, the shape data in the respective steps illustrated in FIG. 11 are each stored as the design data Dd and the simulation data Ds. In this case, the identification codes ((1) to (10)) can be assigned not only to the line-and-space pattern of the wiring layers 200′ which are finally formed, but also to the sidewall films 112 to form the line-and-space pattern.

### (2) Modification 2

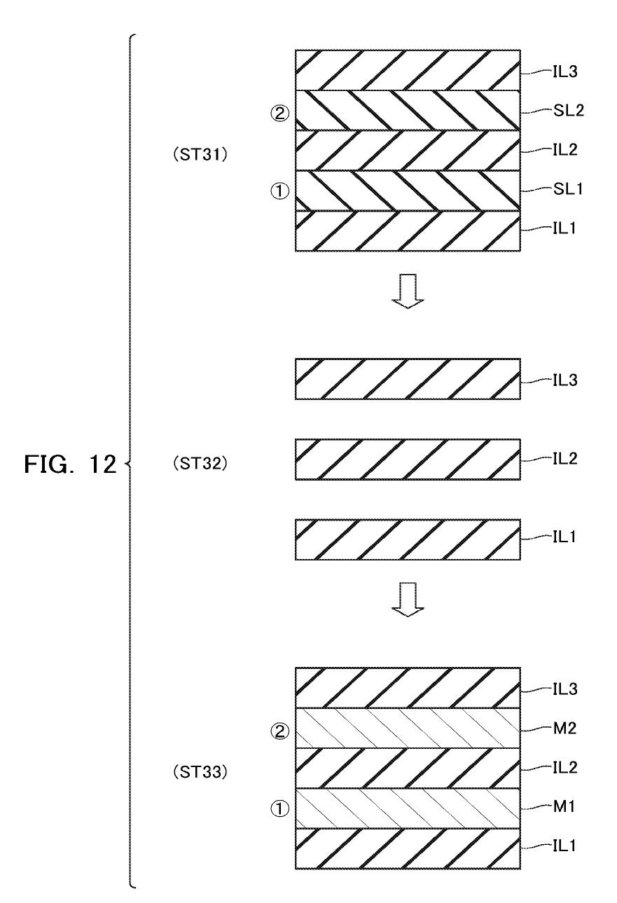

FIG. 12 illustrates the case of employing a lamination step using sacrifice films to form a laminated structure of conductive films and interlayer insulating films.

Assume the semiconductor device that laminates metals (such as tungsten and copper) and interlayer insulating films (such as silicon oxide) in alternation and performs processes to bore a through-hole on the laminated films. In terms of processes, it is difficult for the semiconductor device to form the through-hole after depositing the metal films and the insulating films in alternation from the start. In view of this, to form the laminated structure of the conductive films and the interlayer insulating films, as illustrated in FIG. 12, first, insulating films IL, which will be interlayer insulating films, and sacrifice films SL, such as silicon nitride, are deposited in alternation (ST31 in FIG. 12). Afterwards, after forming a support pillar at a part (not shown), the sacrifice films SL are removed by wet etching (ST32). Then, metal films are deposited on voids from which these sacrifice films SL have been removed by the CVD method or a similar method, thus forming conductive films M (ST33).

In such case, the identification codes can be assigned not only for conductive films M1 and M2 which are the final structures, but also to sacrifice films SL1 and SL2 corresponding to these conductive films M1 and M2.

### [Others]

While certain embodiments have been described, these embodiments have been presented by way of example only, and are not intended to limit the scope of the inventions. Indeed, the novel methods and systems described herein may be embodied in a variety of other forms: furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A simulation device for a semiconductor device, comprising:
a comparator configured to compare design data of a semiconductor device with simulation data of the semiconductor device to extract areas different between the design data and the simulation data;
an identification code assigning unit configured to assign, with respect to extracted areas extracted by the comparator, different identification codes to the extracted areas corresponding to different conductors; and
a short-circuit determining unit that determines whether the extracted areas to which the different identification codes have been assigned are within a predetermined distance or not to determine a short circuit position in the semiconductor device.

2. The simulation device according to claim 1, wherein:
the extracted areas are divided into voxels, and
the identification code assigning unit is configured to assign an identification code to one of the voxels.

3. The simulation device according to claim 2, wherein
the short-circuit determining unit is configured to determine whether the voxels to which the different identification codes have been assigned are within the predetermined distance or not.

4. The simulation device according to claim 1, wherein:
the identification code assigning unit is configured to assign, with respect to the design data, different identification codes to different conductors in the design data, and
the identification code assigning unit is configured to assign, to the extracted areas, an identification code assigned to corresponding design data.

5. The simulation device according to claim 4, wherein:
the extracted area is divided into voxels, and
the identification code assigning unit is configured to assign identification codes to the voxels.

6. The simulation device according to claim 5, wherein
the short-circuit determining unit is configured to determine whether the voxels to which the different identification codes have been assigned are within the predetermined distance or not.

7. The simulation device according to claim 2, wherein
whenever an identification code is assigned to a voxel, the short-circuit determining unit is configured to determine whether another voxel having an identification code different from the identification code is within the predetermined distance or not.

8. A short-circuit determination method for a semiconductor device, comprising:
comparing design data of a semiconductor device with simulation data of the semiconductor device to extract areas different between the design data and the simulation data;
assigning, with respect to extracted areas extracted by the comparing, different identification codes to the extracted areas corresponding to different conductors; and
determining whether the extracted areas to which the different identification codes have been assigned are within a predetermined distance from one another or not to determine a short circuit position in the semiconductor device.

9. The short-circuit determination method according to claim 8, wherein:
the extracted area is divided into voxels, and
the identification code is assigned to the voxels.

10. The short-circuit determination method according to claim 9, wherein
the determining of the short circuit position is configured to determine whether the voxels to which the different identification codes have been assigned are within the predetermined distance or not.

11. The short-circuit determination method according to claim 8, wherein:
with respect to the design data, different identification codes are assigned to different conductors in the design data and
the identification code assigned to the corresponding design data is assigned to the extracted area.

12. The short-circuit determination method according to claim 11, wherein:
the extracted area is divided into voxels, and
the identification code is assigned to the voxels.

13. The short-circuit determination method according to claim 12, wherein
the determining the short circuit position is configured to determine whether the voxels to which the different identification codes have been assigned are within the predetermined distance or not.

14. The short-circuit determination method according to claim 9, wherein
whenever an identification code is assigned to a voxel, the determining the short circuit position is configured to determine whether another voxel having an identification code different from the identification code is within the predetermined distance or not.
